(19) United States
(12) Patent Application Publication
(10) Pub. No.: US 2003/0135382 A1
(43) Pub. Date: Jul. 17, 2003

(54) Self-monitoring service system for providing historical and current operating status

(76) Inventors: Richard Marejka, Nobleton (CA); David Haynes, Streetsville (CA); Louis Ferrante, Nobleton (CA); Guy Birkbeck, Scarborough (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/179,109

(22) Filed: Jun. 25, 2002

Related U.S. Application Data
(60) Provisional application No. 60/348,725, filed on Jan. 14, 2002.
(60) Provisional application No. 60/377,113, filed on Apr. 30, 2002.

(51) Int. Cl. G06F 17/60

(52) U.S. Cl. 705/1; 714/100

(57) ABSTRACT

A system and method for system monitoring. The system monitors parameters and when parameters cross thresholds, the system transmits an event message to the service provider and determines if an alarm should be generated. During system operation, data is collected periodically and new monitoring data is compared with recently stored monitoring data to identify events and alarms. The service provider transmits monitoring interfaces to the customer including current status concurrently with indicators of prior operating states, such as uncleared alarm indicators. The monitoring interfaces selectively show operating status for the monitored environment, domains, systems, or individual monitored components. For each monitored element, a multi-tier arrangement divides the operating status into three operating ranges, such as normal, non-critical, and critical, with current status displayed on the monitoring interfaces on a domain, system, element, or component basis. The customer modifies the thresholds and establishes alarm notification criteria used in the system.

### CROSS-REFERENCE TO RELATED APPLICATIONS

This application claims the benefit of U.S. Provisional Application No. 60/348,725, filed Jan. 14, 2002, and U.S. Provisional Application No. 60/377,113, filed Apr. 30, 2002, the disclosures of which are herein specifically incorporated in its entirety by this reference.

### BACKGROUND OF THE INVENTION

1. Field of the Invention

The present invention relates, in general, to monitoring, reporting, and asset tracking software and systems, and more particularly, to a method and system for monitoring operating status of a number of system and network elements, determining based on user-definable threshold and alarm rules when an reportable event has occurred and when an alarm has occurred, displaying concurrently current and prior operating status of monitored elements, and when appropriate, transmitting notification messages to designated customer monitoring personnel.

2. Relevant Background

The need for effective and cost efficient monitoring of computer and network systems, i.e., systems management, continues to grow at a rapid pace in all areas of commerce. An ongoing difficulty with managing computer systems is tracking changes in the system components and their configurations. There are many reasons system management solutions are adopted by companies including reducing customer and service downtime to improve customer service and staff and customer productivity, reducing computer and network costs, and reducing operating expenditures (including reducing support and maintenance staff needs). A recent computer industry study found that the average cost per hour of system downtime for companies was $90,000 with each company experiencing 9 or more hours of mission-critical system downtime per year. For these and other reasons, the market for system monitoring and management tools has increased dramatically and with this increased demand has come pressure for more effective and user-friendly tools and features.

An important goal of system monitoring tools is to enable monitoring personnel, such as system administrators, to monitor the operating status of a number of monitored elements within their systems. For example, some monitoring tools monitor the operation of an element, such as the central processing unit (CPU) or the system network, and then display or transmit alarms when collected data indicates an element is malfunctioning or operating out of a desired range. Presently, most operating status monitors simply display all previously generated alarms until they are manually cleared and for systems, a single alarm is often provided without an indication of which element's operation cause the alarm. This results in a single element to cause an entire system to be reported with an alarm with typical monitoring tools not providing an efficient mechanism for identifying the alarming element. Further, depending on when the alarm was detected, the alarm may be displayed for an extended period resulting in historical data being displayed to the monitoring personnel rather than current operating states. As a result, monitoring personnel typically spend a great deal of their time simply clearing old or stale alarms trying to determine the current operating status for a system.

Hence, there remains a need for an improved system and method for monitoring computer systems that allows monitoring personnel to readily identify and monitor past and current operating status of monitored elements within a plurality of systems and/or networks. Preferably, such a method and system would also provide notification for alarms to user-selected individuals based on user criteria. Further, such a method and system would allow a user to provide input as to when alarms are generated for some or all of the monitored elements.

### SUMMARY OF THE INVENTION

A self-monitoring system is provided that includes event and alarm detection and alarm notification mechanisms that operate to address the above and other deficiencies with existing monitoring systems. The system automatically monitors levels of usage or other monitoring parameters and when measured parameters cross monitoring points or thresholds, the system transmits an event message to the service provider and determines if an alarm should be generated, e.g., the event is an alarm event. During operations, data is collected periodically such as every ten minutes and new monitoring data is compared with the most recently stored monitoring data to identify events and alarm states. Significantly, the service provider displays monitoring interfaces or screens to the customer user that include current status information concurrently with indicators of prior operating states (such as with uncleared alarm indicators). The monitoring interfaces are adapted to allow a user to quickly view operating status for the entire monitored system, domains or portions of the system, and individual monitored elements and components within such monitored elements. For each monitored element, a multi-tier or multi-threshold arrangement can be used to divide the operating status into three or more operating levels, such as normal, non-critical, and critical, with each such status being displayed on the monitoring interfaces on a domain, system, element, and/or component level. Importantly, the customer user is able to set and modify the thresholds and to establish notification criteria used in the system and again, these rules may vary by domain, system, element, and/or level to provide additional monitoring flexibility.

According to one aspect of the invention, a method is provided for monitoring operation of computing environment and reporting current and historical operating information to a customer user. The method includes storing a threshold rule set at the customer environment or for access by the environment. The threshold rule set includes threshold settings that define boundaries between normal, non-critical, and critical operating ranges for a set of monitored elements within the monitored environment. First and second sets of operating data are collected at first and second times for the monitored elements. For each of the monitored elements, the method continues with determining whether one of the thresholds has been crossed which indicates a change in the operating range for that element. The first collected operating data is transmitted to a service provider or central server for determination of initial operating status or ranges for each of the monitored elements. Then, for monitored elements that have crossed thresholds, an event message is transmitted to the service provider to indicate the change in operating status for that element. A monitoring display or page is generated including at least one visual indicator or cue of the current operating state for one of the monitored elements. Typically, the most severe operating state is shown, i.e., critical before non-critical and non-critical before normal. The monitoring display is then transmitted to a user node for viewing.

In some embodiments, the threshold rule set includes definitions for alarm states for each of the monitored elements, which may indicate a severity and optionally, a persistence or longevity of a particular operating state. The method then includes when an event is detected for a monitored element further determining if an alarm state also exists and if so, transmitting an alarm message to the service provider. The monitoring display then includes the alarm state for the monitored element (if that element is being reported). Typically, the monitoring display includes alarm states until they have been cleared by the customer user. The method may further include upon receipt of an alarm message determining whether an alarm notification should be generated based on previously stored notification rules. If an alarm notification is generated the notification rules may further indicate the format of the notification, how the notification is to be transmitted, and to which recipients. The threshold rules may set differing thresholds and alarm definitions for different portions of the computing environment, such as by domain, by system, or some other useful grouping. Further, the method may include updating the threshold rules based on input received from the customer user.

### BRIEF DESCRIPTION OF THE DRAWINGS

FIG. 1 illustrates a self-monitoring service system with event and alarm status reporting according to the present invention generally showing a service provider system and its services linked by networks and relays to a large number of monitored systems;

FIG. 2 illustrates one embodiment of a service system of showing an alarm provider within the customer system for detecting operating events and alarm states within the customer system and an event status mechanism within the service provider system that in combination with an alarm mechanism provides many of the event status monitoring functions of the invention;

FIG. 3 is a flow chart illustrating event and alarm monitoring processes provided by the systems of FIGS. 1 and 2;

FIG. 4 illustrates a monitoring display or screen displayed on the user interface of the customer system showing the current and past operating status of domains within the customer system or environment;

FIG. 5 illustrates an operating status summary display or screen as displayed on the user interface for systems within a domain selected from the monitoring display of FIG. 4 useful for summarizing historic and current operating status for each monitored element within each system;

FIG. 6 illustrates a status detail display or screen displayed on the user interface upon selection of a monitored element icon for a system summarized in FIG. 5 useful for displaying historic and current operating information for components within the selected monitoring element or category; and

FIG. 7 illustrates an event history display or screen displayed on the user interface to provide additional operating information and history for a particular component selectable from the status detail display of FIG. 6.

### DETAILED DESCRIPTION OF THE PREFERRED EMBODIMENTS

The present invention is directed to a method and system of providing self-monitoring services to clients or customers with improved monitoring and reporting of both historic and current operating status for monitored elements or parameters within the customer environment. Significantly, monitoring displays are provided by at user interfaces within the customer environment to allow customer system administrators to visually determine for each domain, and in preferred embodiments, systems, monitored elements, and components, which of two or more operating states (such as normal, non-critical, and critical) the monitored portion of the environment is currently operating in and whether historic problems or alarms exist within that portion that need to be cleared or otherwise addressed. Further, the method and system are adapted to accept user input for setting of an event and alarm rule set that is used to establish monitoring thresholds used for each element to identify events, to identify for each event whether an alarm should be generated, and if an alarm is generated, whether an alarm notification should be transmitted and to whom the notification should be addressed.

More specifically, a service system is provided that includes data collection devices within the customer system to periodically collect monitoring and asset information and to pass this information to a service provider system for processing and storage. An alarm provider is used at the customer system to process two consecutively collected sets of monitoring data against or with a user defined set of threshold rules to identify events and alarm states. The alarm provider than transmits event messages to the service provider along with any identified alarms. The service provider includes an event status mechanism that operates in combination with a reporting web server and an alarm mechanism to process the received monitoring data, to display a series of monitoring screens or displays on a user interface within the customer environment and to transmit alarm notifications, when appropriate based on the alarm notification settings within the threshold rules, to customer-established recipients.

The monitoring displays are configured to concurrently provide visual cues as to the current operating status of the monitored customer environment, such as with status symbols, icons, or shaded or colored backgrounds, and prior detected and uncleared alarm states, such as with steady or flashing symbols, icons, or other indicators. In one embodiment, the historic and current operating information is provided on a domain or network basis, a system basis, a monitored element or parameter basis, and/or a component basis, with the display arrangement being selectable by the customer user or system administrator.

In the following description, the system is described as using specifically configured forwarding or fan-out relays within the customer system to provide a cascaded pipeline that controls the transmission of data and/or messages between a monitored relay or system and a service provider system and allows the customer system to be readily scaled up and down in size to include hundreds or thousands of monitored systems and nodes. However, other network and data transmission configurations and/or techniques may be used to practice the invention. While specific monitored elements and useful threshold numbers and settings are provided, these are provided as examples and for explanation and not as limitations. Modifications to these examples, such as using more than or less than two thresholds or a differing number of thresholds for the same or different ones of the monitored elements, will be apparent to those skilled in the art having an understanding of the following description of the invention.

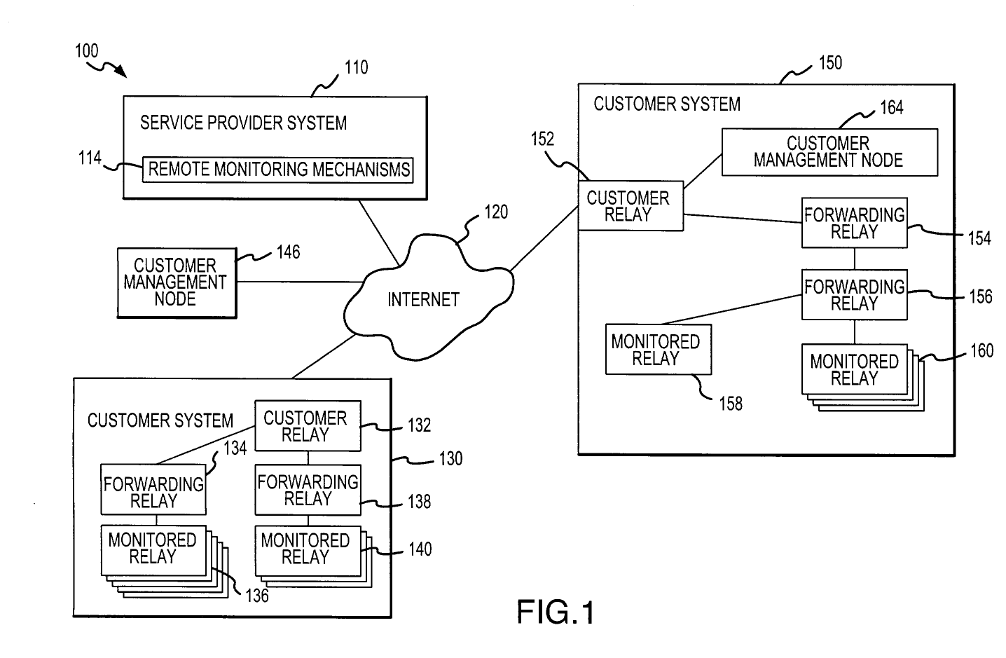

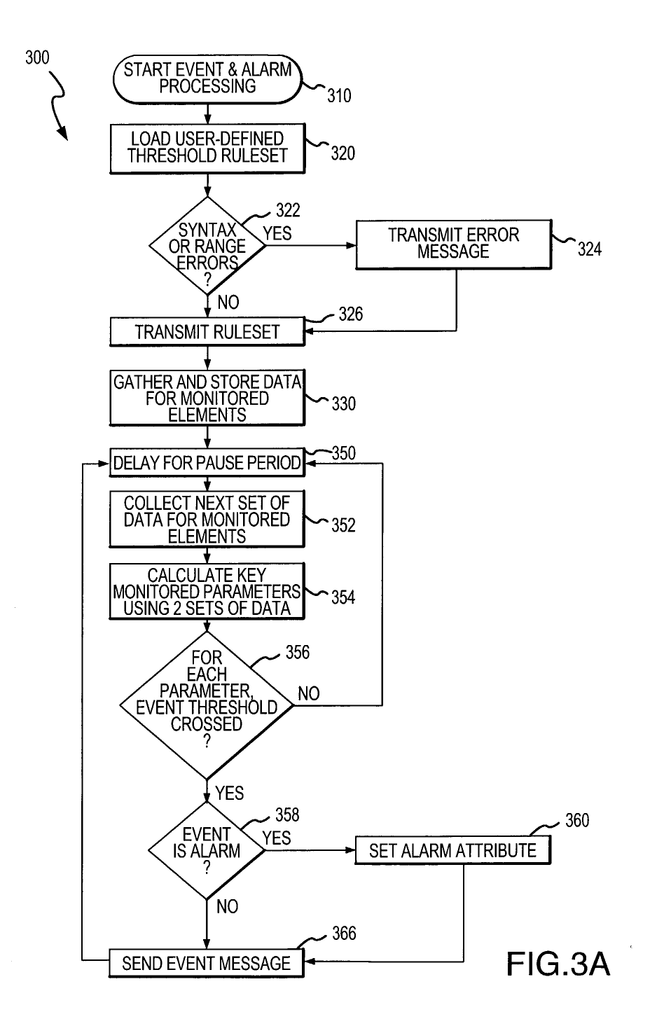

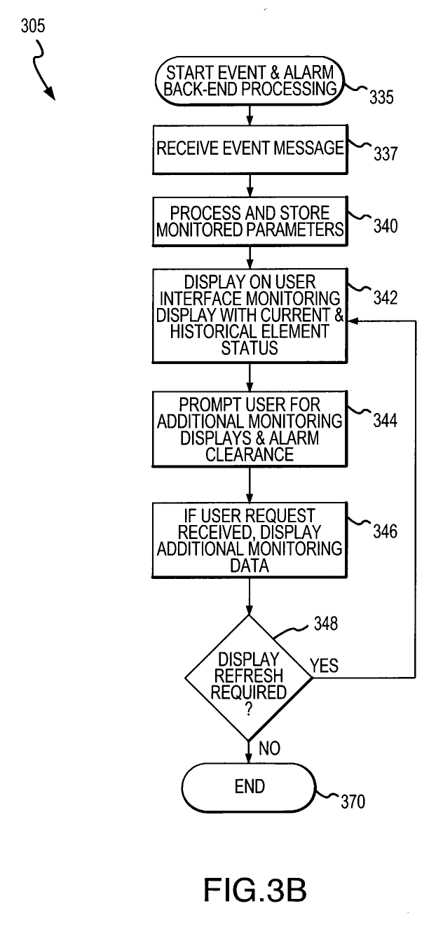

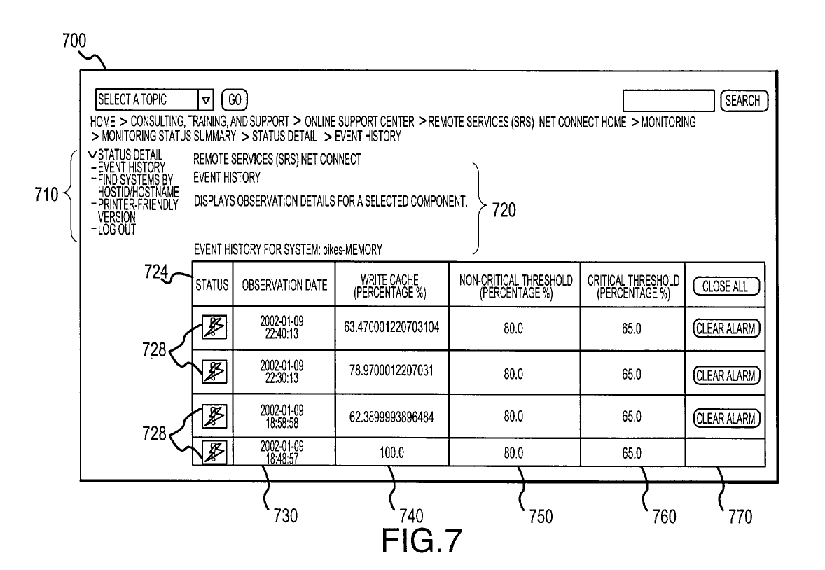

With this brief overview in mind, the following description begins with a description of a typical service system of the invention with reference to FIG. 1 and continues with a more specific description of the various components included within a service provider system, a forwarding relay, and a monitored system to provide the desired functions of the invention. Event and alarm status monitoring and reporting based on user-defined operating thresholds and alarm rule sets are then described fully with reference to FIGS. 3-7.

Referring to FIG. 1, a self-monitoring service system 100 is shown that according to the invention provides historic and current system monitoring and reporting. The system 100 includes a service provider system 110 with remote monitoring mechanisms 114 that function to process collected data and provide event, alert, trending, status, and other relevant monitoring data and asset survey information in a useable form to monitoring personnel, such as via customer management nodes 146, 164. The useable form may include a set or series of monitoring displays provided as a graphical user interface that display current operating status (e.g., an indication which of a number of operating ranges was most recently detected) along with indicators of any prior or historic operating problems, i.e., uncleared alarm states. As will become clear, the monitoring personnel or customer users are able to define thresholds that separate or define the operating ranges and alarm notification rules and are also able to make report filtering selections that results in the display of select portions of the customer environment and monitored elements or parameters.

The service provider system 110 is linked to customer systems or sites 130, 150 by the Internet 120 (or any useful combination of wired or wireless digital data communication networks). The communication protocols utilized in the system 100 may vary to practice the invention and may include for example TCP/IP, SNMP, a customized protocol, or any combination thereof. The service provider system 110 and customer systems 130, 150 (including the relays) may comprise any well-known computer and networking devices such as servers, data storage devices, routers, hubs, switches, and the like. The described features of the invention are not limited to a particular hardware configuration or to particular hardware and software components.

The service system 100 is adapted to control data transmissions, including user login messages, user profile additions and modifications, and monitoring reports provided based on user classes, within the customer systems 130, 150 and between the service provider system 110 and the customer systems 130, 150. In this regard, the system 100 includes a cascaded pipeline architecture that includes within the customer systems 130, 150 linked customer or Internet relays 132, 152, forwarding (or intermediate or fan-out) relays 134, 138, 154, 156, and monitored relays 136, 140, 158, 160. The monitored relays 136, 140, 158, 160 are end nodes or systems being monitored in the system 100 (e.g., at which configuration, operating, status, and other data is collected). The forwarding relays 134, 138, 154, 156 are linked to the monitored relays 136, 140, 158, 160 and configured to support (or fan-out) monitored systems to forwarding relay ratios of 500 to 1 or larger. In one embodiment, the pipeline is adapted to control the transmission of data or messages within the system, and the forwarding relays act to store and forward received messages (from upstream and downstream portions of the pipeline) based on priorities assigned to the messages. The customer relays 132, 152 are positioned between the Internet 120 and the forwarding relays 134, 138, 154, 156 and function as an interface between the customer system 130, 150 (and, in some cases, a customer firewall) and the Internet 120 and control communication with the service provider system 110.

The system 100 of FIG. 1 illustrates that multiple forwarding relays 134, 138 may be connected to a single customer relay 132 and that a single forwarding relay 134 can support a large number of monitored relays 136 (i.e., a large monitored system to forwarding relay ratio). Additionally, forwarding relays 154, 156 may be linked to provide more complex configurations and allow more monitored systems to be supported within a customer system 130, 150. Customer management nodes 146, 164 used by users for logging into the system and displaying and, thus, monitoring collected and processed system data may be located anywhere within the system 100 such as within a customer system 150 as node 164 is or directly linked to the Internet 120 and located at a remote location as is node 146. In a typical system 100, more customer systems 130, 150 would be supported by a single service provider system 110 (e.g., many customer environments or accounts) and within each customer system 130, 150 many more monitored relays or systems (e.g., a typical customer environment may include thousands of components and systems organized in a variety of ways such as by domain, network, business department, building, geography, and the like) and forwarding relays would be provided, with FIG. 1 being simplified for clarity and brevity of description.

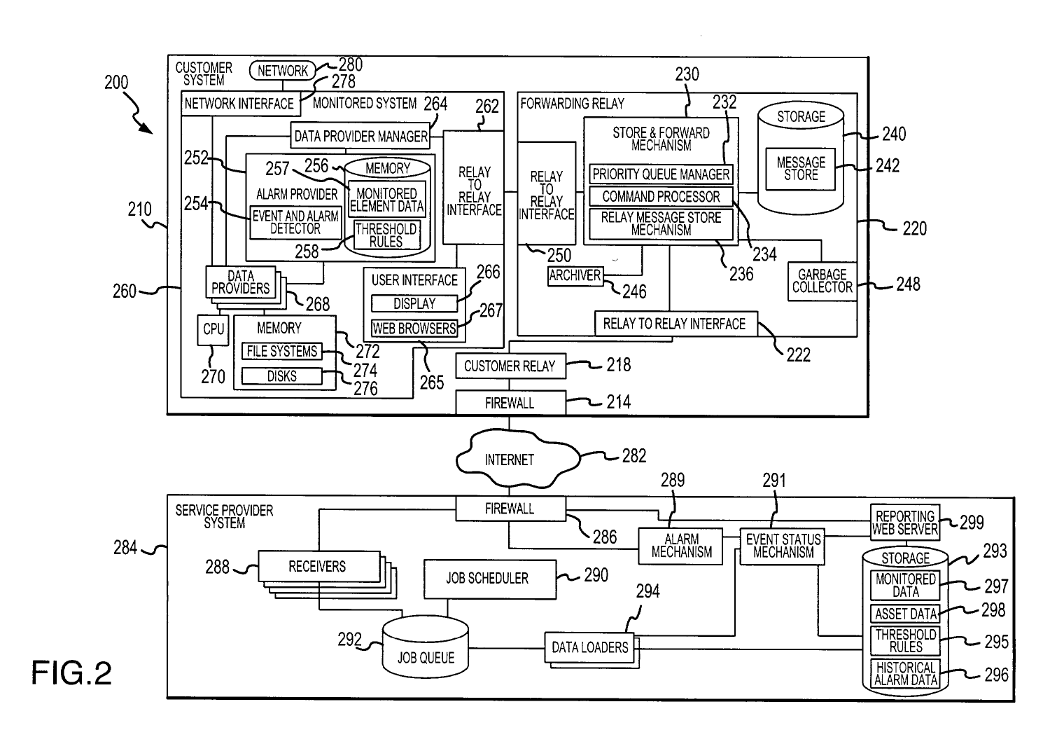

FIG. 2 shows a monitoring service system 200 that includes a single customer system 210 linked to a service provider system 284 via the Internet 282. FIG. 2 is useful for showing more of the components within the monitored system or relay 260, the forwarding relay 220, and the service provider system 284 that function separately and in combination to facilitate collection and transmittal of monitoring and asset data and to provide the customer administration and data viewing features of the invention.

As shown, the customer system 210 includes a firewall 214 connected to the Internet 282 and a customer relay 218 providing an interface to the firewall 214 and controlling communications with the service provider system 284. The customer system 210 includes a forwarding relay 220 linked to the customer relay 218 and a monitored system 260. The forwarding relay 220 functions, in part, to provide a useful communication link between the monitored system 260 and the service provider system 284 and accepts data from upstream and downstream sources and reliably and securely delivers it to the recipient. Throughout the following discussion, the monitored system 260 will be considered the most upstream point and the service provider system 284 the most downstream point with data (i.e., “messages”) flowing downstream from the monitored system 260 to the service provider system 284.

The forwarding relay 220 accepts data from upstream and downstream sources and reliably and securely delivers it downstream and upstream, respectively. The relay 220 caches file images and supports a recipient list model for upstream (fan-out) propagation of such files. The relay 220 manages the registration of new monitored systems and manages retransmission of data to those new systems. In some embodiments, the forwarding relay 220 implements a priority scheme to facilitate efficient flow of data within the system 200 such as by designating a message with an alarm as highest priority, event messages as next highest priority, and monitoring and asset data messages have the next lower priorities. The forwarding relay 220 includes two relay-to-relay interfaces 222, 250 for receiving and transmitting messages to connected relays 218, 260. A store and forward mechanism 230 is included for processing messages received from upstream and downstream relays and for building and transmitting messages. This may be thought of as a store and forward function that is preferably provided within each relay, of the system 200 (and system 100 of FIG. 1) and in some embodiments, such message building and transmittal is priority based. To provide this functionality, the store and forward mechanism 230 includes a priority queue manager 232, a command processor 234, and a relay message store mechanism 236 and is linked to storage 240 including a message store 242.

Briefly, the priority queue manager 232 is responsible for maintaining a date-of-arrival ordered list of commands and messages from upstream and downstream relays. The command processor 234 coordinates overall operations of the forwarding relay 220 by interpreting all command (internal) priority messages and also acts as the file cache manager, delayed transmission queue manager, and relay registry agent. The relay message store mechanism 236 acts to process received message and commands and works in conjunction with the priority queue manager 232 to build messages from data in the message store 242 based on the priority queue library and to control transmission of these built messages. The mechanism 236 functions to guarantee the safety of messages as they are transmitted within the system 200 by creating images of the messages in storage 240 and implementing a commit/destroy protocol to manage the on-disk images. In general, a “message” represents a single unit of work that is passed between co-operating processes within the system 200. The priority queue manager 232 functions to generate priority queues. This allows the relay 220 to obtain a date-ordered set of priority queues directly from the mechanism 230.

Generally, the message store 242 stores all messages or data received from upstream and downstream sources while it is being processed for transmittal as a new message. The store 242 may take a number of forms. In one embodiment, the store 242 utilizes a UNIX file system to store message images in a hierarchical structure (such as based on a monitored system or message source identifier and a message priority). The queue library implements a doubly-linked list of elements and allows insertion to both the head and tail of the list with searching being done sequentially from the head of the queue to the tail. Messages are typically not stored in the queue but instead message descriptors are used to indicate the presence of messages in the message store 242. The queue manager 232 may create a number of queues in memory as part of the priority queue manager 232 such as a queue for each priority level and extra queues for held messages which are stored awaiting proper registration of receiving relays and the like. A garbage collector 248 is provided to maintain the condition of the reliable message store 242 which involves removing messages or moving messages into an archival area (not shown) with the archiver 246 based on expiry policy of the relay 220 or system 200.

In some embodiments, the forwarding relay 220 with the store and forward mechanism 230 functions to send information based upon the priority assigned (e.g., by the transmitting device such as the monitored system 260 or service provider system 284) to the message. Priorities can be assigned or adjusted based on the system of origination, the function or classification of the message, and other criteria. For example, system internal messages including alarms from monitored system 260 may be assigned the highest priority and sent immediately (e.g., never delayed or within a set time period, such as 5 minutes of posting). Alerts or event messages from the monitored system 260 may be set to have the next highest priority relative to the internal messages and sent immediately or within a set time period (barring network and Internet latencies) such as 5 minutes. Nominal trend or monitoring data is typically smaller in volume and given the next highest priority level. High-volume collected data such as asset or configuration data is given lowest priority. Of course, the particular priorities assigned for messages within the system 200 may be varied to practice the prioritization features of the present invention. Again, it will be understood that the event and alarm monitoring and reporting features of the invention are not dependent on the particular arrangement of the forwarding relay or the use of prioritization while these features are useful for controlling communications between customer systems 210 and the service provider system 284.

According to an important aspect of the invention, the system 200 is adapted for monitoring elements or parameters of the monitored system 260 on an ongoing or at least periodic basis (such as once every minute, every 5 minutes, or every 10 minutes or another smaller or larger time period). Generally, the monitored elements or parameters are selected to collect adequate data on key system or network components and to monitor their operation. In this regard, the monitored system 260 includes components to be monitored and surveyed such as one or more CPUs 270 running one or more packages with a plurality of patches, memory 272 having file systems 274 (such as storage area networks (SANs), file server systems, and the like) and disk systems 276, and a network interface 278 linked to a customer or public network 280 (such as a WAN, LAN, or other communication network).

A user interface 265 is included to allow a client user to communicate, e.g., login and request information, with the service provider system 284 (and specifically with the event status mechanism 291 and alarm mechanism 293 as discussed with reference to FIGS. 3-7) and to allow viewing of operating status monitoring reports and asset survey information reports of the monitored system 260. The user interface 265 typically includes a display 266 (such as a monitor) and one or more web browsers 267 to allow viewing of screens of collected and processed data including monitoring information including uncleared alarms, current and historical status, trends, and other information useful for monitoring and evaluating operation of the monitored system 260. The web browsers 267 provide the access point for users of the user interface 265.

Data providers 268 are included to gather monitoring information and perform asset surveys and collect operating and other data from the system 260. A data provider manager 264 is provided to control the data providers 268 and to transmit messages to the forwarding relay 220 including assigning a priority to each message. Preferably, the data providers 268 and data provider manager 264 and the relays 220, 218 consume minimal resources on the customer system 210. In one embodiment, the CPU utilization on the monitored system 260 is less than about 0.01 percent of the total CPU utilization and the CPU utilization on the relay system is less than about 1 percent of the total CPU utilization.

The data providers 268 are configured to at least gather data needed to determine when events occur (i.e., when operating thresholds are crossed) and when alarms are to be generated. Briefly, the data providers 268 are configured to at least collect data for monitoring a number of elements for each system. For example, but not as a limitation, the data providers 268 can be configured to gather monitoring data to monitor system reboots, to monitor operation of the CPU 270, the memory 272 including the file systems 274 and disks 276, and to monitor the network interface operations 278. The data providers 268 typically collect data for a number of monitoring elements or parameters such as: run queue, utilization, and load average for the CPU 270; utilization of memory 272 including monitoring the page rate scan, the percentage page utilization, SWAP spaces utilization, percentage read cache hits, and percentage write cache hits; operation of each disk unit 276 including average wait time and average service time; file system operations such as for each local mount point including percentage of space used and percentage of inodes used; and operation of the network interface 278 for each such interface including monitoring network defers, network errors, network collisions, and the like.

The data providers 268 also typically collect configuration data and other asset survey data (i.e., all data necessary to create the asset survey delta reports discussed above). The data providers 268 operate on a scheduled basis such as collecting monitored element data every 10 minutes (or other smaller or larger time period useful for efficiently monitoring operations without taxing the system operations or communications) and only performing asset survey once a week or some relatively longer period of time. In some cases, the client user via the user interface 265 or a service provider system 284 operator either accepts the default collection periods of the data providers or adjusts the periods on a domain, system, or component basis. The data provider manager 264 functions to coordinate collection of data by the data providers 268 and to broker the transmission of data with the relay 220.

Significantly, an alarm provider 252 is provided to operate in conjunction with the data providers 268 and manager 264 to periodically determine system usage statistics from the collected data and compare those statistics with a set of user-defined or definable threshold values to identify operating events and alarms for a set of monitored elements. In this regard, the alarm provider 252 includes an event and alarm detector or mechanism 254 that performs data comparisons and generates event and alarm messages. Memory 256 is provided for storing monitored element data 257 for at least the last data collection performed by the data providers 268 for the monitored elements and in some cases the current data collection is also stored in memory 256.

Threshold rules 258 are also stored in memory 256 and may be default values or be modified or set by the customer (such as via user interface 265 during operation of the system 200). The set of threshold rules will be explained in more detail with reference to FIGS. 3-7 but briefly include for each monitored element one or more threshold or operating levels that define the boundaries between operating ranges. The operating ranges may include a wide variety of useful labels and be defined based on the particular hardware and software being monitored and on the customer's operational needs. In one embodiment, two thresholds are used for each monitored element to define three operating ranges (i.e., normal, non-critical, and critical), which can be thought of as a three-tiered status hierarchy. A crossing of a threshold in either direction between two monitoring periods is labeled an event with detected events being transmitted to the service provider system 284 and indicates the monitored element or parameter changed from one operating state to another. The threshold rules also indicate when alarms should be generated upon detection of an event and when such alarms should result in an alarm notification being sent to customer personnel or only be reported in a monitoring display at user interface 266 (as will be explained in detail with reference to FIGS. 3-7).

The service provider system 284 is linked to the Internet 282 via the firewall 286 for communicating messages with the customer relay 218 and the forwarding relay 220. The service provider system 284 includes receivers 288 which are responsible for accepting data transmissions from the customer system 210 and brokering the data to the appropriate data loaders 294 and to the customer administrator 291. Typically, received messages or jobs are queued in job queue 292 and the job queue 292 holds the complete record of the data gathered by a provider 268 until it is processed by the data loaders 294. The job scheduler 290 is responsible for determining which jobs are run and in which order and enables loaders 294 to properly process incoming data. The data loaders 294 accept data from the receivers 288 via the job queue 292 and process the data into final format which is stored in storage 293 (or database 292) as threshold rules 295, historical alarm data 296, monitored data 297, or asset data 298. The data loaders 294 are generally synchronized with the data providers 268 with, in some embodiments, a particular data loader 294 being matched to operate to load data from a particular data provider 268.

The threshold rules 295 include for each customer system 210 either default or customer-defined threshold levels for each of the monitored elements, alarm generation criteria for each of the monitored elements, and notification rules indicating when alarms should be transmitted, how the messages are to be transmitted, and the recipients. Note, each of these rules or settings can be set for the entire customer system 210, for each monitored system 260, for each domain or network within system 210, for each system within a domain, and even on a component-by-component basis. The historical alarm data 295 stores for each customer system 210 historical operating information for the monitored elements typically including event and alarms, time of detection, and domain, system, and component information.

According to an important aspect of the invention, the service provider system 284 includes an event status mechanism 291 in communication with the data loaders 294, storage 293, and reporting web server 299. The function of the customer administrator 291 is discussed fully with reference to FIGS. 3-7. Briefly, however, the event status mechanism 291 acts to periodically update monitoring displays, screens, or interfaces provided or displayed on user interface 265 by processing received monitored data 297 and historical alarm data 296. Significantly, the monitoring displays provide visual cues as to the historic operating status of monitored elements, such as by using the historical alarm data 296 to indicate the presence of uncleared alarms and to provide links or other access to event histories. Concurrently, current operating status is provided by including visual indicators such as colored backgrounds or other markings to indicate which of the operating range was most recently detected. Both the alarm and current status indicators are typically provided on a hierarchical basis. For example, the detection of an alarm or lower or less desirable operating range is reported when it is detected within the presently selected viewing set, e.g., an alarmed component within a system would result in an alarm state being indicated when viewing the component as well as the component's system and domain.

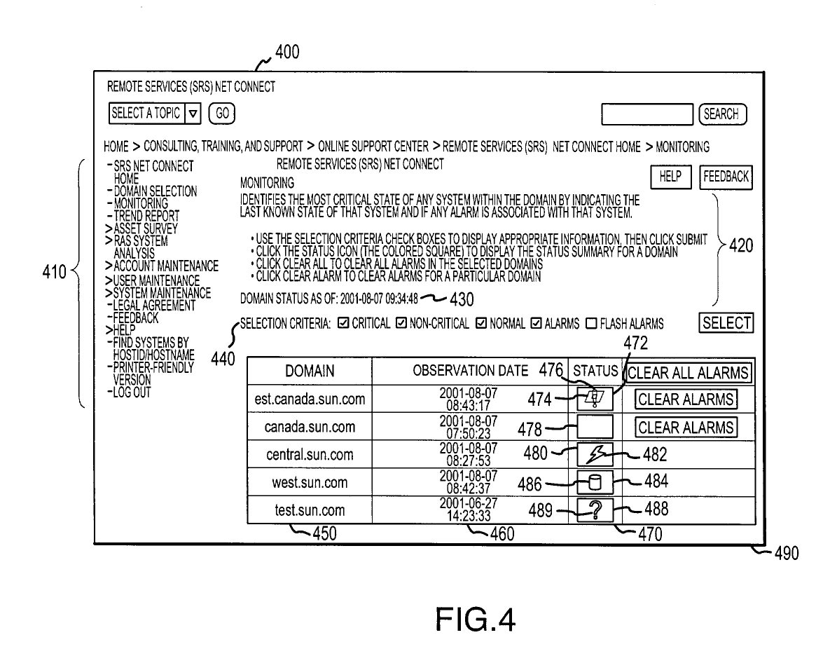

The event status mechanism 291 in some embodiments creates all monitoring reports or displays provided to the user interface 265 but in other preferred embodiments, the event status mechanism 291 works with the reporting web server 299 for communicating with the user interface 265 to request and receive user input (such as login information and modifications to the threshold rules). The event status mechanism 291 acts to pass current and historical operating data to the reporting web server 299 which generally functions to cumulate all the processed data and transmit or report it to the user interface 265 in the form of monitoring displays or interfaces (see FIGS. 4-7). The types of displays may vary but typically include time-based monitoring data for time-based monitoring data evaluated against a set of performance level metrics (i.e., threshold levels) and may be in HTML, XML, or other formats. The specific formatting of the monitoring, trending, asset, and other reports and displays is not as relevant to this invention as is the concurrent display of historic and current operating states of the monitored system 210 and monitored elements in a manner that allows a user to quickly narrow or drill down in the information to view monitoring data for specific monitored elements or for specific portions of the customer system 210.

The alarm mechanism 289 is provided to generate and transmit alarm notifications based on alarm rules in the threshold rules 295 and on received monitored data. As will become clear, the alarm provider 252 typically determines when alarms should be generated and transmits alarm messages separately or as part of an event message to the service provider system 284. At this point, the alarm mechanism 289 acts based on the threshold rules to determine if an alarm notification should be transmitted, the form such notification should take, (such as a page, an e-mail, and the like) and the proper set of recipients. The alarm notifications may be set to be transmitted based on the severity of the alarm and/or based on the longevity of the alarm (is the alarm state being detected over 2 or more data collection periods) with the longevity being set by the user and stored in the threshold rules 295.

While shown as separate devices, the functions of the receivers 288, alarm mechanism 289, job scheduler 290, event status mechanism 291, data loaders 294, and reporting web server 299 may be provided by any number of mechanisms that may be located on one or more servers or other computing devices. Further, the storage 293 may be located in one or more data storage devices within the system 284 or remote but linked to the system 284 and may include databases or any other useful data structure.

Prior to discussing the operations of the specific embodiments of systems 100 and 200, it may be useful to describe the inventive threshold monitoring system in a more general manner that is not tied to the specific configurations shown in FIGS. 1 and 2. The threshold monitoring system of the invention includes a number of different programs that typically run on a number of different systems. An event provider (such as alarm provider 252 and/or event and alarm detector 254) is a program that runs on a customer or user system(s) to evaluate the current system parameters against a supplied rule set (such as threshold rules 258). An event loader program (such as data receivers and loaders 288, 294) is run on the service provider system (such as system 284) to interpret the messages received from the event provider(s) and to load the contents of the received messages into a database or other data structure. An event processor program (such as event status mechanism 291 and alarm mechanism 289) is also run on the service provider system to notify the customer system user (and other subscribed parties) of the existence of an alarm event. A rule set generator is typically run on the customer system as part of an initial installation process to generate the initial default rule set (such as threshold rules 258). The rule set may be modified at any time by customer using a standard editor program. The threshold event monitoring system further includes a web portal reporting system(s) (such as reporting web server 299) that runs on the service provider system (although often on a separate physical computer system) to present event monitoring status reports to the customer system via a standard web browser interface (such as at user interface 265).

Referring now to FIGS. 3A-7, the operation of the systems 100 and 200 (and the general threshold event monitoring system described above) are described with particular detail provided for the operation of the service provider system 200 and its alarm provider 252, alarm mechanism 289, and event status mechanism 291. FIGS. 3A and 3B illustrate an exemplary event and alarm process 300 along with back-end processing 305 of the present invention as carried out by system 200 of FIG. 2. At 310, the process 300 is begun with the customer system 210 being configured to include the alarm provider 252 and data providers 268 as well as other illustrated components and to establish a communication link with the service provider system 284 (including setting up a customer account for new customers).

For new users, a threshold rule set, which is typically generated by or with the customer user as part of the installation process, is stored at the monitored system 210 at 258 (and at step 236, at the service provider system 284 at 295 for use by the event and alarm detector 254 in detecting events and alarms and by the event status mechanism 291 in generating monitoring displays as shown in FIGS. 4-7). The rule set may be a default one supplied by the service provider or one created by the user, and once stored, the rule set can be modified by the customer user at any time during the process 300. As discussed previously, an important aspect of the invention is the division of the operating data for a number of monitored elements into operating ranges with the use one or more threshold levels or points that can be either default or user-defined. Again, the particular monitored elements may be varied to practice the invention and the number of operating ranges and thresholds for each monitored element can be varied to suit the monitored parameters, the needs of the customer, and other factors. Additionally, the particular thresholds values and quantities may be varied within a customer system 200 by domain, by system, or by monitored element.

With the wide variety of threshold and operating ranges in mind, the following discussion will be simplified for clarity to discuss one preferred embodiment that uses two thresholds for each monitored element to establish a three-tier operating range or status hierarchy. The three operating ranges may be labeled, for example but not as a limitation, normal, non-critical, and critical. In monitoring displays provided by the event status mechanism 291, a current status indicator or alert is provided to visually indicate which of these three operating ranges was most recently detected. A large number of indicators may be used such as text labels, symbols, or as in the embodiment shown in FIGS. 4-7, a background colored to indicate the operating range (e.g., green for normal, yellow for non-critical, and red for critical).

At 320, a user-defined threshold rule set is created and stored at 258. In this embodiment, there are two thresholds for each monitored element or parameter. At the beginning of 320, each threshold is set at default levels for that monitored element as shown in Table 1 and at 320 the user may alter the defaults or accept the defaults.

TABLE 1
Default Alarm Thresholds and Utilization Levels

| Element/Severity | Green | Yellow | Red |
|---|---|---|---|
| CPU average load (x in queue) | 0-3 | 3-7 | 7+ |
| Memory page scan rate (per second) | 0-100 | 100-200 | 200+ |
| Memory % of page utilization | 0-70 | 70-90 | 90+ |
| Memory SWAP space utilization | 0-70% | 70%-85% | 85%+ |
| Memory % read cache hits | 100%-80% | 80%-65% | 65%− |
| Memory % write cache hits | 100%-80% | 80%-65% | 65%− |
| Disk average wait time (milliseconds) | 0-5 | 5-20 | 20+ |
| Disk average service time | 0-30 | 30-50 | 50+ |
| (milliseconds) | | | |
| File system % of space used | 0-85% | 85%-95% | 95%+ |
| File system % of inodes used | 0-85% | 85%-95% | 95%+ |
| Network interface defers | 0-2 | 2-10 | 10+ |
| Network interface errors | 0-2 | 2-10 | 10+ |
| Network interface collisions | 0-15 | 15-30 | 30+ |

Table 1 provides an example of the types of monitored elements that can be monitored for events and alarms to provide a system administrator or other user of the system 200 of a quick picture of the operating status of the monitored system 210.

In addition to the threshold settings, a system administrator sets at 320 the alarm rules (e.g., creates an alarm rules file) for the monitored system 210 which are stored in the threshold rules 258 (and, at step 326, at 295 for use by the event and alarm detector 254 and the alarm mechanism 289). A default rule set may be provided initially to provide a visual alarm when an operating status becomes non-critical or critical and accompany this with an e-mail, page, or other message being sent to a system administrator. More preferably, the system administrator or other user establishes more specifically who should receive alarm notifications (in addition to alarms being shown on monitoring displays), how the notifications are transmitted, and under what conditions for each of the monitored elements (and optionally, for each domain, system, or other grouping of monitored components). For example, a user can specify the following: alarms are to be visually provided when operations become non-critical and/or critical (as will be discussed with reference to FIGS. 4-7) and no notifications are to be sent; alarms are displayed and alarm notifications sent only when a operating status enters the critical operating range; or visually display alarms and send notifications when operations enter both the non-critical and critical stages from a lower operating range.

In addition to being based on severity (entering an operating range), alarms may be defined to only be generated (or a notification sent) based on longevity or persistence or a combination of severity and longevity. For example, an alarm may be defined for a particular monitored element to be generated when a non-critical operating status is detected for a period of time (e.g., 30 minutes or 3 sampling periods when a delay or sampling pause of 10 minutes is used or any other useful time period) and immediately when a critical operating status is detected. This longevity requirement is useful for eliminating “spike” alarms. Again, these alarm rules may be set differently for each monitored element within a single system or in different domains or systems. Also, during operation of the system 200, the user can modify the threshold rules 258 to modify the thresholds and/or the alarm rules.

At 322, the rule set or threshold rules 258 are examined for syntax or range errors. If any are found at 322, an error message is transmitted at 324 to the service provider system 284. At 326, the rule set, less any rules that have range or syntax errors identified at 322, is transmitted to the service provider system 284 for storage as threshold rules 295. Steps 322, 324, and 326 allow synchronization of the rule set 258 at the customer system 210 with the set 295 maintained at the service provider system 284 prior to any reporting of monitoring events and/or alarms.

At 330, the data providers 268 operate to collect an initial set of data to enable calculation of operating status for the monitored elements. This information is stored in memory 257 for later use in determining which operating range the monitored element is operating within, whether there has been a change in ranges (i.e., a threshold has been crossed resulting in an event), and whether an alarm state exists for that element. Each of these determinations is performed by the event and alarm detector 254 using the threshold rules defined at 320. Data is typically gathered periodically, such as every 10 minutes or other time period selected to provide effective current status monitoring while controlling the burden placed on the processing and communications capacities of the customer system 210. The delay for the pause or monitoring period occurs at 350 and then at 352 the next set of data is collected for the monitored elements.

At 354, the event and alarm detector 254 acts to compare the new set of data with the previously stored data 257 (and if necessary, performing statistical calculations). At 356, the detector 254 uses the two sets of data for each monitored element or parameter and retrieved user-defined thresholds from rules 258 to determine if a threshold has been crossed (i.e., an event has occurred for that element). If no threshold is crossed, another delay period is begun at 350 prior to performing more data sampling (note, if a persistence rule is in place for a monitored element, the persistence within a particular operating range is checked to see if an alarm is generated and an alarm message sent to the service provider system 284). If a threshold is crossed, a change in operating status has occurred and the detector 254 determines which operating status the element is in, such as normal, non-critical, or critical, and an event message is generated for transmittal to the service provider system 284. The event message typically includes a monitored system identification (such as a monitored relay serial number), a timestamp of when the second data collection was performed, a monitored element name, the present operating range, the observed value, and the thresholds.

The message may also include an alarm or indicate that an alarm is to be generated. At 358, the detector 254 acts to process the alarm rules (such as severity and persistence) and compare the rules to the observed value. The alarm rules may be relatively simple providing for each monitored element which threshold should act as an alarm threshold. In other words, the non-critical threshold may be set as the alarm threshold and then alarms generated when either the non-critical threshold or the critical (higher threshold) is crossed. Alternatively, the critical threshold may be set as the alarm threshold and alarms generated only when the status changes from normal or non-critical to critical. If the alarm rules are not met, the event message is transmitted at 366 and operations return to waiting for another set of monitoring data at 350.

If an alarm rule is met, the event message is modified to include an alarm, i.e., an alarm attribute is set. At this point, a determination can be made as to whether an alarm notification is to be generated and transmitted via page, e-mail, or otherwise to personnel designated in the threshold rules. In some embodiments these notifications are performed by the event and alarm detector 254, in other embodiments, the event and alarm message is sent to the service system provider 284 and the alarm mechanism 289 determines in notification rules have been satisfied, and in many embodiments, subscription and the method of notification is defined via a web-based user interface (not as part of the event monitoring process 300 and 305). Otherwise, the event and alarm message is transmitted at 366 to the service provider system 284 for further processing and an alarm notification is generated and transmitted (either by the alarm provider 252 or the alarm mechanism 289). Note, while not shown, an ongoing synchronization between the rule set 258 at the customer system 210 and the rule set 295 at the service provider system 284 is performed as part of the process 300, such as by periodically performing steps 320 to 326 or performing these steps upon detection of a change by the customer.

Concurrently with the event and alarm detection and messaging steps 350 to 366, the event status mechanism 291 and web server 299 perform back-end processing 305 that starts at 335 to provide one or more monitoring reports and/or displays that are displayed on user interface 265. The specific arrangement configuration of the monitoring displays may be varied to practice the invention with the more important features including the display of current operating status for monitored elements and concurrently displaying an indication of historical operating status, such as by indicating the presence of uncleared alarms. At 337, an event message sent at 366 is received at the service provider system 284. At 340, the event status mechanism 291 functions to process gathered element data 297 and received event and alarm data along with stored historical alarm data 296. At 342, the mechanism 291 works with the reporting web server 299 to generate a monitoring display including the current and historical operating status for the monitored elements.

For example, FIG. 4 illustrates one useful monitoring display which includes a listing 410 of links to other reporting provided by the service provider system 284 (such as trend and asset reporting. Additionally, the listing 410 provides an optional link to a domain selection screen or interface (not shown) which allows a user to filter the amount of information reported in the monitoring report by domain or network (or other subdivision) within the customer system 210. In this fashion, the user can select to only monitor a particular portion at a time. At 420, a explanatory text section provides user instructions that indicates that the user can narrow the information included within the display, clear alarms, and/or input additional or other monitoring displays that provide different and/or more detailed information. At 430, a timing of the determination of the current status is provided. At 440, the user can filter the reported information by choosing one or more of the selection criteria to view domains that have particular current operating statuses or that have uncleared alarms. Additionally, the user can request that alarms be indicated with flashing alarm indicators (i.e., shown in the example screenshot with exclamation marks).

The monitoring display 400 includes a table with information arranged in columns including a domain column 450 listing each domain included in the monitoring report (as requested by at the domain selection or including all domains within the customer or monitored system 210, 260). Column 460 provides the date and time of the most recent data collection and column 490 provides the user with the ability to clear alarms within a particular domain or to clear all alarms by selecting a clear alarm button.

According to an important aspect of the invention, the status column 470 is provided to visually indicate the current status of the domain as well as providing historic operating status (such as historic, uncleared alarm states). While numerous techniques and variations may be used to provide such visual information, the current status indicators may be background boxes 472, 478, 480, 484, and 488 that in a preferred embodiment are colored to indicate the current status of the domain. However, other visual techniques such as a background patterns, differently shaped backgrounds, text, and the like may be used to provide a visual current status indicator. In one embodiment, these background boxes are colored green when the operating status is normal, yellow when the operating status is non-critical, red when the operating status is in the critical range, and gray when the current status is unknown (such as for box 488 in which a question mark icon is further provided to indicate that no data is available for this domain). The operating status is the highest or most severe detected operating status range for all of the monitored elements within the domain (from normal to non-critical to critical).

Historical data is presented in the foreground to indicate if alarms exist that have not yet been cleared. In the example shown, an exclamation mark 476 is used to indicate that at least one uncleared alarm exists from the most recent data status determination or prior status determinations. Again, other markings, text, or visual techniques may be used to provide such an alarm indicator. A second foreground symbol or indicator may be included to allow the user to quickly identify the monitored components or aspects that has caused the operating status to enter an undesirable range, such as non-critical or critical, or caused an alarm. As illustrated a series of picture icons or symbols are provided for each of the monitored components (which, again, can be varied to provide a link to a monitored component to still practice the invention). As shown in FIGS. 4-7, a lightening bolt is used for system reboot, a chip for CPU, a diagonal rectangle for memory, a cylinder for disk, a tree structure for file systems, and a block connection figure for networks. In the above manner, the single monitoring display 400 acts to quickly provide current and historic operating information for selected domains within a monitored system.

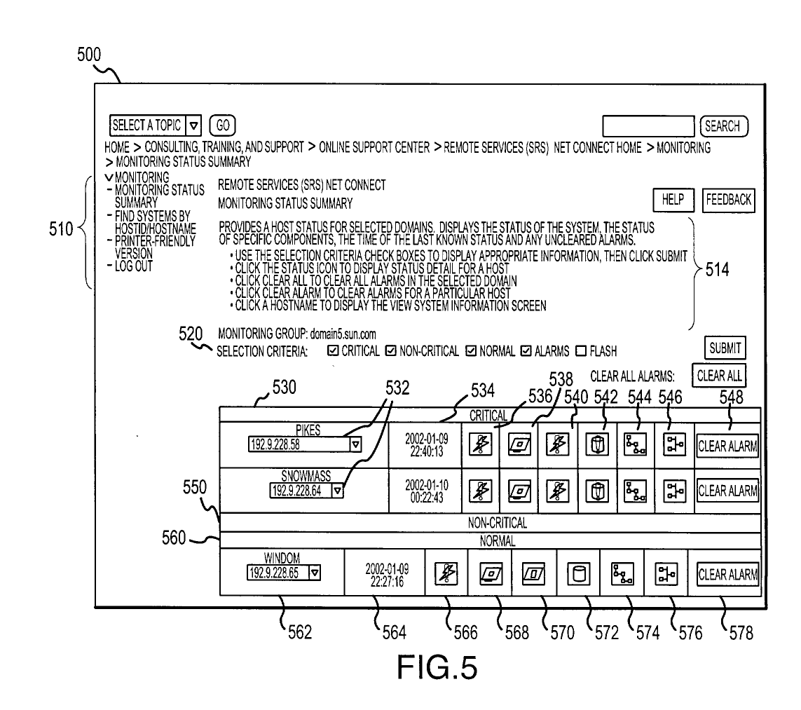

Referring again to FIG. 3, the process 300 continues with prompting the user for additional monitoring displays and/or clearance of alarms. Alarm clearance is prompted in display 400 with the buttons in column 490. The request for additional displays may be handled with links or the use of selectable status icons in column 470 which allow a user to quickly drill down to find more status information for a particular domain (or based on other criteria as will be discussed with reference to FIGS. 5-7). At 346, the requested additional monitoring displays are created by the event status mechanism 291 and displayed on the user interface 265. At 348, the currently displayed monitoring display, such as display 400, is refreshed after a set refresh period has passed. For example, the event status mechanism 291 may operate to periodically (such as every 5, 10, or 15 minutes or other time period) refresh the information provided in the monitoring display 400 including the time 430. The display features of the process 300 then continue at 340 or end at 370. Note, that the monitoring display steps 340, 342, 344, 346, 348 proceed independently and often concurrently with the event and alarm monitoring steps 350, 352, 354, 356, 358, 360, 362, 364, 366.

FIG. 5 illustrates a monitoring status summary display 500 that may be selected from display 400 by selecting one of the status icons in column 470. The display 500 includes a link list 510 and a textual explanation area 514 to assist a user in filtering the monitoring information and instructing the user on clearing alarms by system. As shown, the selection or filtering criteria 520 has been chosen or set to display all systems within the monitored domain that have operating status of normal, non-critical, or critical and/or that have uncleared alarms. In the illustrated embodiment, two systems are shown to have critical operating status in section 530, no systems with non-critical operating status in section 550, and one system with currently normal operating status but at least one historical, uncleared operating alarm as shown in section 560. The critical systems are identified at 532 an identification and address. At 534, the date and time of the most recent collected status information is provided. The following columns provide an indication of the operating status (current and historic) for each of the monitored aspects or components with alarms being cleared with buttons in column 548.

Column 536 provides reboot status (i.e., current status with an uncleared alarm indicator), column 538 provides CPU status (i.e., current status with no alarms indicated, column 540 provides memory status (i.e., current status with an alarm indicator), column 542 provides disk status (i.e., current status with an alarm indicator), column 544 provides file system status (i.e., current status with no alarm indication), and column 546 provides network status (i.e., current status with no alarm indication). Similarly, the system indicated at 562 was most recently observed or status checked as indicated at 564 with the results provided in columns 566-576 for the same monitored components discussed for the critical portion 530 and clearance of the alarm allowed in column 578 for all alarms (with only the one alarm being shown in column 566).

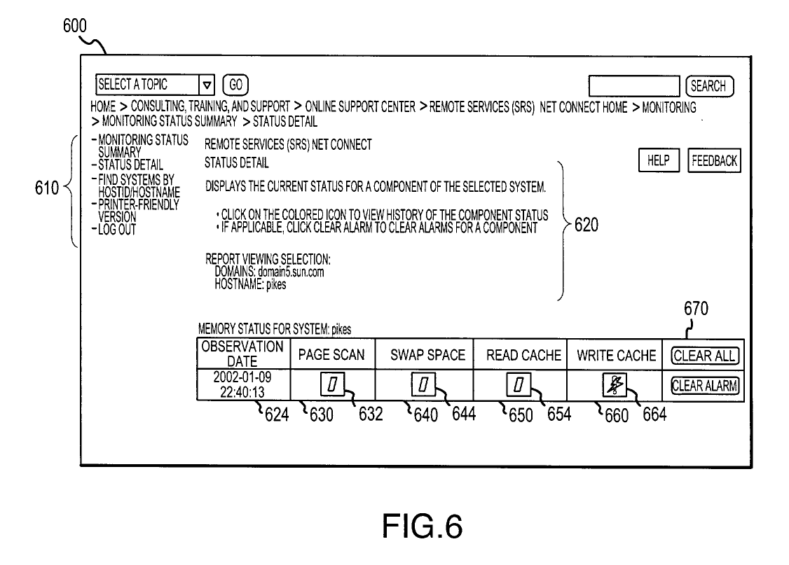

By selecting a status icon within one of the systems in display 500, more specific status information may be obtained by the user for a particular monitored component. FIG. 6 illustrates a status detail display 600 for the memory component for a particular system including a link list 610 and an explanatory text area 620. A table is provided organizing the status detail for the indicated system into columns. Column 624 provides the date and time the particular component (e.g., the memory) was last observed or the operating status determined. Status information for each monitored element of the component is provided in columns 630, 640, 650, and 660 with status icons 632, 644, 654, and 664, respectively. In this fashion, the monitored element or elements that have alarms or are currently operating in an undesirable operating range can be quickly and visually determined by a user.

By selecting a status icon in FIG. 6, the user is able to further drill down into the status information and obtain historical data of the operations of a particular monitored element for a particular monitored component. The event history display 700 includes a link list 710 and an explanatory text area 720 identifying the information displayed and identifying the system and selected component. Column 740 provides an indication of the monitored element (e.g., write cache operations) and an observed level. Column 724 is an operating status at the time event was identified with the status icons 728 indicating the particular event (or operating status at the time of the event). Column 730 provides the time and date of the event observation. Column 750 provides the non-critical threshold (i.e., the threshold value between the normal and non-critical operating ranges) and column 760 provides the critical threshold (i.e., the threshold value between the non-critical and critical operating ranges) at the time the event was observed. The combination of the monitoring displays 400, 500, 600, and 700 provides a user with current and historical operating status information on a larger domain and system level which can quickly be narrowed to identify the particular monitored components and monitored elements that are causing operating alerts or events and generating alarms. The timing of the alarms and events can also be quickly determined along with the threshold levels that were in place at the time of the observed events.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

We claim:

1. A method of monitoring and reporting historical and current operating status within a customer computer and network environment, comprising:
obtaining first operating data collected at a first time at the customer environment;
storing the first operation data;
obtaining second operation data collected at a second time after the first time at the customer environment;
processing the first operation data to determine a historical operating state and the first and second operation data to obtain derived data products indicative of a current operating state of the customer computer and network operating environment;
generating a monitoring screen including a current operating status indicator corresponding to the current operating state and a historical operating status indicator corresponding to the historical operating state; and
transmitting the monitoring screen over a communications network to a customer node for display on a user interface.

2. The method of claim 1, wherein the second operation data includes an event message indicating a change in operating state between the first and second time and wherein the current operating state is determined from the second operating data.

3. The method of claim 2, wherein the event message includes a crossed threshold to indicate the operating state change, and wherein the current operating states are selected from first, second, and third operating ranges separated by two of the thresholds.

4. The method of claim 3, wherein the thresholds are input at a user node in the customer environment.

5. The method of claim 3, wherein the event message includes an alarm corresponding to the crossed threshold and wherein the current operating status indicator includes a first portion indicating one of the operating ranges and a second portion indicating an alarm state.

6. The method of claim 1, wherein the current operating state indicator is a background symbol and the historical operating status indicator is a foreground symbol positioned on the background symbol.

7. The method of claim 4, wherein the background symbol is a color selected from a group of colors corresponding to a group of operating states.

8. A method of monitoring operation of a customer computing environment and reporting current and historic operating information to a customer user, comprising:
storing at the customer environment thresholds for a set of monitored elements, wherein for each of the monitored elements a non-critical threshold is provided to define a boundary between a normal operating range and a non-critical operating range and a critical threshold is provided to define a boundary between the non-critical operating range and a critical operating range;
collecting first and second sets of operating data for the monitored elements at a first and second time;
determining for each of the monitored elements whether one of the thresholds has been crossed between the first and second times;
transmitting at least a portion of the first and second sets of operating data to a service provider;
for the monitored elements having a determined threshold crossing, transmitting an event message to the service provider;
at the service provider, determining a current one of the operating ranges for each of the monitored elements based on the received operating data and the event messages;
generating a monitoring display including a current status indicator for the current operating range for at least one of the monitored elements; and
transmitting the monitoring display for viewing by the customer user at a user node.

9. The method of claim 8, wherein the monitoring display further includes a historical alarm indicator corresponding to an operating state for one of the monitored elements based on the first set of operating data.

10. The method of claim 9, wherein the operating state based on the first set of operating data includes an alarm state determined from the first set of operating data based on an alarm rule set.

11. The method of claim 10, wherein the current status indicator is a background icon and the past operating status indicator is positioned to overlap the background icon.

12. The method of claim 10, wherein the alarm rule set is modified based on input provided at the user node.

13. The method of claim 10, wherein the alarm rule set includes a severity parameter and a longevity parameter for one of the monitored elements and wherein the alarm state is determined when the severity and the longevity parameters are met by the sets of operating data.

14. The method of claim 10, further including obtaining notification rules defining when alarm notifications are generated in response to the alarm states and a recipient list for the alarm notifications and including transmitting the alarm notifications to entities on the recipient list.

15. The method of claim 8, wherein customer environment includes a plurality of domains comprising systems of monitored components, each of the monitored elements being linked to one of the monitored components and wherein the monitoring display includes a current status indicator for at least one of the domains.

16. The method of claim 15, wherein the operating ranges are designated by severity with the non-critical operating range being more severe than the normal operating range and the critical operating range being more severe than the non-critical operating range and wherein the current status indicator for the one domain corresponds to a monitored element having an operating range with the highest severity.

17. The method of claim 15, wherein the current status indicator is a selectable icon, and further including when the current status indicator is selected, generating and transmitting a status summary monitoring display for display on the user node including a listing of the systems for the domain corresponding to the selected indicator and including a current status indicator for each of the monitored components in the listed systems.

18. The method of claim 17, wherein the current status indicators are selectable icons, and further including in response to a selection of one of the current status indicators, generating and transmitting a status detail monitoring display including a current status indicator for each of the monitored elements corresponding to the monitored component and system linked to the selected one of the current status indicators.

19. A computer system for monitoring a computing environment, comprising:
a memory component that stores a rule set defining thresholds between operating ranges for monitored operating parameters within the computing environment;
a data collection component that gathers a first and a second set of operating data in the computing environment corresponding to the monitored operating parameters;
a memory component that stores the operating ranges of the monitored operating parameters determined based on the first set of operating data; and
an event status component that updates the operating ranges of the monitored operating parameters to a current status based on the second set of operating data; and
a report serving component that transmits a monitoring display to a user node for viewing including a visual indicator corresponding to the current status of at least one of the monitored operating parameters and a visual indicator corresponding to the stored operating range for at least one of the monitored operating parameters that was not updated.

20. The system of claim 19, further including a detector component that determines whether an operating event has occurred by determining for each of the monitored operating parameters whether one of the thresholds has been crossed between collection of the first and second sets of operating data and that when an event is determined to have occurred transmits an event message to the event status component for use in the updates.
